(19) United States
(12) Patent Application Publication
(10) Pub. No.: US 2023/0016799 A1
(43) Pub. Date: Jan. 19, 2023

(54) ARTIFICIAL INTELLIGENCE BASED METHOD AND SYSTEM FOR CONTROLLING MULTIMEDIA DEVICE

(71) Applicant: 1THEFULL PLATFORM LIMITED, Seoul (KR)

(72) Inventors: Seung-Yub KOO, Gyeonggi-do (KR); Dong-Uk LEE, Gyeonggi-do (KR); Joon-Gu HEO, Seoul (KR); Young-Ju JANG, Seoul (KR); Seung-June PAEK, Seoul (KR); Young-Joon KIM, Gyeonggi-do (KR); Yong-Woong KIM, Seoul (KR); Ji-Woo SEO, Seoul (KR)

(21) Appl. No.: 17/782,389

(22) PCT Filed: Nov. 3, 2020
(86) PCT No.: PCT/KR2020/015229

§ 371 Date: Jun. 3, 2022

(30) Foreign Application Priority Data
Jan. 20, 2020 (KR) 10-2020-0007180

(51) Int. Cl. G10L 15/22; G10L 15/16

(52) U.S. Cl. CPC G10L 15/22; G10L 15/16

(57) ABSTRACT

An artificial intelligence (AI) based method for controlling a multimedia device according to an embodiment of the present disclosure makes it possible to ensure accuracy in detection and interpretation of a voice command of a user by enabling an AI care device to control the volume of the multimedia device by itself or allow the user to control the volume of the multimedia device by transmitting voice guidance for volume control to the user when the AI care device does not accurately detect the voice signal of the user due to the audio signal of the multimedia device and the voice signal of the user applied to the AI care device at the same time.

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/KR2020/015229, filed Nov. 3, 2020, which claims priority to the benefit of Korean Patent Application No. 10-2020-0007180 filed in the Korean Intellectual Property Office on Jan. 20, 2020, the entire contents of which are incorporated herein by reference.

### BACKGROUND

### 1. Technical Field

The present disclosure relates to an artificial intelligence (AI) based method and system for controlling a multimedia device.

### 2. Background Art

As the global population is aging fast, there is a growing interest in IT technology industry for seniors.

Recently, artificial intelligence (AI) electronic devices such as smart speakers which identify users' voice commands and provide information (weather, music, news, etc.) requested from the users by means of audio are being developed fast.

In particular, these AI electronic devices such as smart speakers are becoming more and more useful for seniors or older adults living alone.

However, even in the case of AI electronic devices such as smart speakers being developed in recent years, when voice commands of users (seniors or older adults living alone, etc.) and external noise (TV audio, etc.) are applied at the same time, the voice commands of the users are inaccurately recognized, thereby failing to perform the users' desired operations.

In relation to the smart speakers, Korean Patent No. 10-2053534 discloses an ‘elderly care providing method using an AI speaker’ that identifies and prevents diseases, for example, depression through the AI speaker, notifies facility information based on location, and provides information to users at predetermined times based on collected information before the users' request.

### SUMMARY

The present disclosure is directed to providing an artificial intelligence (AI) based method and system for controlling a multimedia device with improved accuracy in detection and interpretation of a voice command of a user by enabling an AI care device to control the volume of the multimedia device by itself or allow the user to control the volume of the multimedia device by transmitting voice guidance for volume control to the user when the AI care device does not accurately detect the voice signal of the user due to the audio signal of the multimedia device and the voice signal of the user applied to the AI care device at the same time.

An embodiment of the present disclosure for solving the above-described technical problem provides an artificial intelligence (AI) based method for controlling a multimedia device including (a) receiving, by an input unit 103 (a microphone) of an AI care device 101, a voice signal S1 of a user 105 and an audio signal S3 of a multimedia device 107 which outputs multimedia content at the same time; (b) determining, by a determination unit 109 of the care device 101, whether it is possible or impossible to extract only the voice signal S1 from the voice signal S1 and the audio signal S3 applied at the same time; and (c) generating, by a control unit 111 of the care device 101, a control signal S5 to be transmitted to the multimedia device 107 or the user 105 when it is impossible to extract only the voice signal S1.

Additionally, there is provided an AI based system for controlling a multimedia device including a multimedia device 107 to generate an audio signal S3 while outputting multimedia content; and an AI care device 101 including an input unit 103 to receive a voice signal S1 of a user 105 and the audio signal S3 at the same time; a determination unit 109 to determine whether it is possible or impossible to extract only the voice signal S1 from the voice signal S1 and the audio signal S3 applied at the same time; and a control unit 111 to generate a control signal S5 to be transmitted to the multimedia device 107 or the user 105 when it is impossible to extract only the voice signal S1.

According to an embodiment of the present disclosure, it is possible to ensure accuracy in detection and interpretation of a voice command of a user by enabling an artificial intelligence (AI) care device to control the volume of a multimedia device by itself or allow the user to control the volume of the multimedia device by transmitting voice guidance for volume control to the user when the AI care device does not accurately detect the voice signal of the user due to the audio signal of the multimedia device and the voice signal of the user applied to the AI care device at the same time.

### BRIEF DESCRIPTION OF THE DRAWINGS

FIG. 1 is a block diagram showing an artificial intelligence (AI) based system for controlling a multimedia device according to an embodiment of the present disclosure.

FIG. 2 is a block diagram showing an AI based system for controlling a multimedia device according to another embodiment of the present disclosure.

FIG. 3 is a block diagram showing an AI based system for controlling a multimedia device according to another embodiment of the present disclosure.

FIG. 4 is a flowchart showing an AI based method for controlling a multimedia device according to another embodiment of the present disclosure.

FIG. 5 is a flowchart showing an AI based method for controlling a multimedia device according to another embodiment of the present disclosure.

FIG. 6 is a flowchart showing an AI based method for controlling a multimedia device according to another embodiment of the present disclosure.

### DETAILED DESCRIPTION

Hereinafter, some embodiments of the present disclosure will be described in detail through the exemplary drawings. It should be noted that in adding the reference signs to the elements of each drawing, like reference signs denote like elements as possible even though they are indicated on different drawings. Additionally, in describing the present disclosure, when a certain detailed description of relevant known elements or functions is determined to obscure the subject matter of the present disclosure, the detailed description is omitted.

Furthermore, in describing the elements of the present disclosure, the terms “first”, “second”, A, B, (a), (b), and the like may be used. These terms are only used to distinguish one element from another, and the nature of the corresponding element or its sequence or order is not limited by the term. It should be understood that when an element is referred to as being “connected”, “coupled” or “linked” to another element, it can be directly connected or linked to other element, but intervening elements may be “connected”, “coupled” or “linked” between each element.

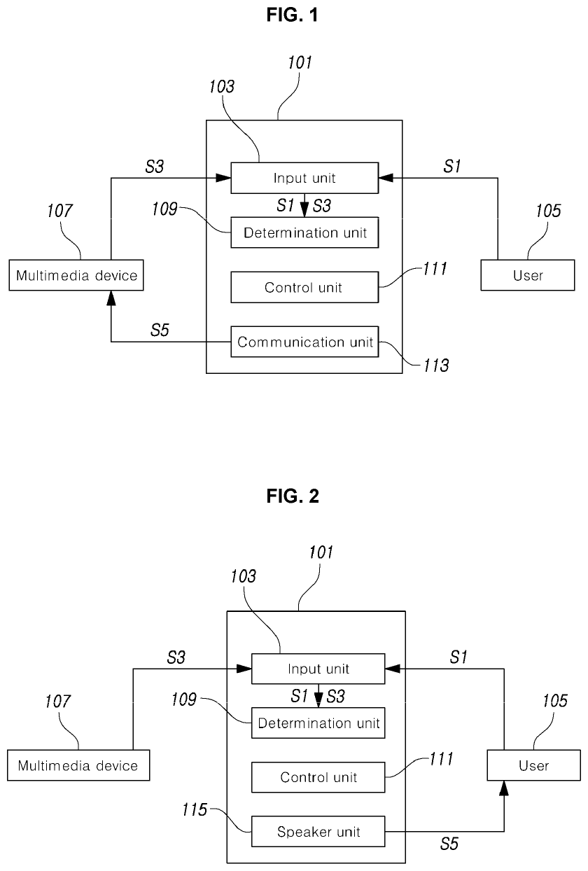

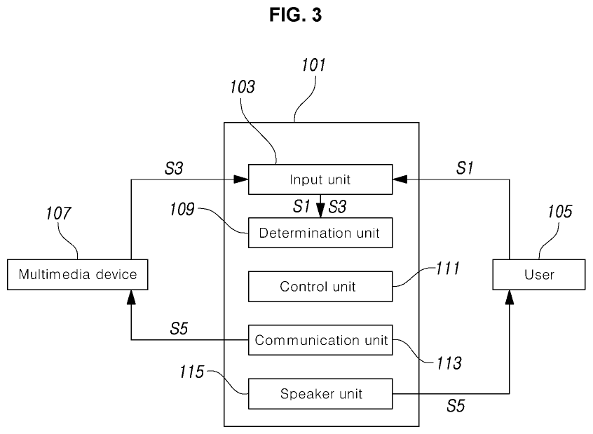

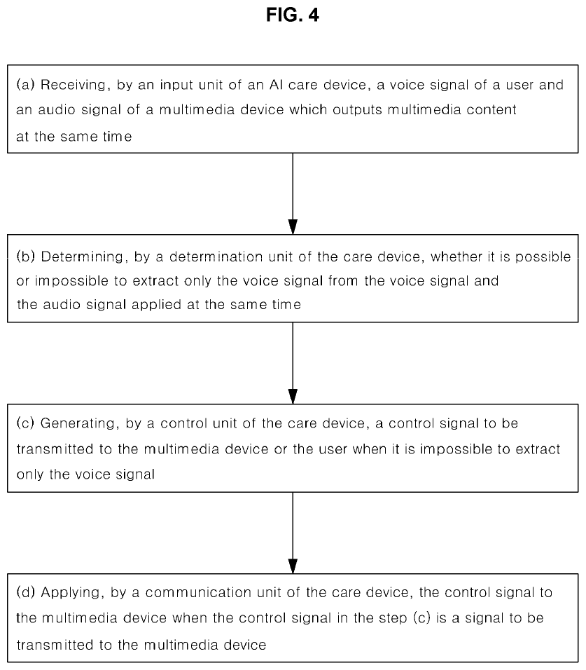

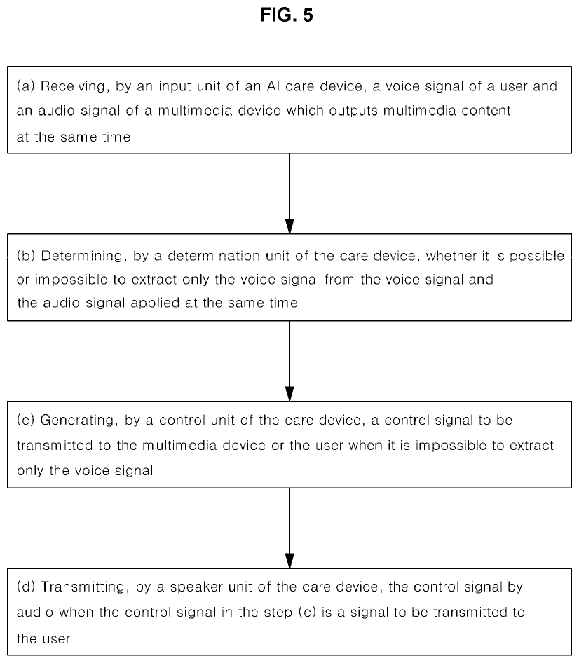

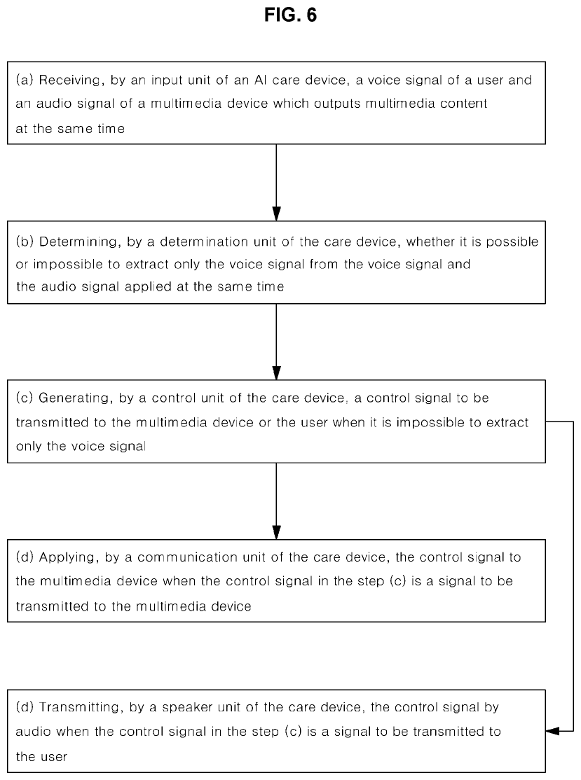

FIG. 1 is a block diagram showing an artificial intelligence (AI) based system for controlling a multimedia device according to an embodiment of the present disclosure. FIG. 2 is a block diagram showing an AI based system for controlling a multimedia device according to another embodiment of the present disclosure. FIG. 3 is a block diagram showing an AI based system for controlling a multimedia device according to another embodiment of the present disclosure. FIG. 4 is a flowchart showing an AI based method for controlling a multimedia device according to another embodiment of the present disclosure. FIG. 5 is a flowchart showing an AI based method for controlling a multimedia device according to another embodiment of the present disclosure. FIG. 6 is a flowchart showing an AI based method for controlling a multimedia device according to another embodiment of the present disclosure.

As shown in the drawings, the AI based method for controlling a multimedia device according to an embodiment of the present disclosure includes (a) receiving, by an input unit 103 of an AI care device 101, a voice signal S1 of a user 105 and an audio signal S3 of a multimedia device 107 that outputs multimedia content at the same time; (b) determining, by a determination unit 109 of the care device 101, whether it is possible or impossible to extract only the voice signal S1 from the voice signal S1 and the audio signal S3 applied at the same time; and (c) generating, by a control unit 111 of the care device 101, a control signal S5 to be transmitted to the multimedia device 107 or the user 105 when it is impossible to extract only the voice signal S1.

Hereinafter, each step will be described in detail.

To begin with, in the step (a), the input unit 103 of the AI care device 101 receives the voice signal S1 of the user 105 and the audio signal S3 of the multimedia device 107 that outputs the multimedia content at the same time.

The AI care device 101 may be, for example, a robot, a smartphone or a smart speaker, and an elderly care app may be installed on the AI care device 101.

The input unit 103 of the AI care device 101 is provided as a microphone to receive the voice signal S1 of the user 105.

Here, the user 105 may be, for example, an older adult.

Additionally, the input unit 103 of the AI care device 101 receives the audio signal S3 from the multimedia device 107 that outputs multimedia content at the same time as the voice signal S1 of the user 105.

Here, the multimedia device 107 may be provided as various types of electronic devices including display devices and audio devices, for example, televisions (TVs), mobile communication terminals, laptop PCs and desktop PCs.

The multimedia device 107 may include a display to display a video signal of various multimedia content and a speaker to output the audio signal S3.

Subsequently, in the step (b), the determination unit 109 of the AI care device 101 determines whether it is possible or impossible to extract only the voice signal S1 from the voice signal S1 and the audio signal S3 applied at the same time.

That is, in the step (b), the determination unit 109 determines if a voice (command) of the user 105 can be detected by separating only the voice signal S1 from the voice signal S1 and the audio signal S3 applied at the same time.

The determination unit 109 may determine whether it is possible or impossible to extract only the voice signal S1 from the voice signal S1 and the audio signal S3 applied at the same time based on the accumulated/stored past voice signals (voice commands, voice calling) continuously applied from the user 105.

More specifically, the determination unit 109 may determine whether it is possible or impossible to extract only the voice signal S1 from the voice signal S1 and the audio signal S3 applied at the same time, using at least one of sound intensity (amplitude), pitch (frequency) or tone (waveform shape) in the accumulated/stored past voice signals (voice commands, voice calling) continuously applied from the user 105.

That is, as a result of comparing the voice signal S1 with the audio signal S3, when all or at least one of sound intensity (amplitude), pitch (frequency) or tone (waveform shape) is within a preset error range, it may be determined that it is impossible to extract only the voice signal S1 from the voice signal S1 and the audio signal S3 applied at the same time.

Subsequently, in the step (c), when it is impossible to extract only the voice signal S1, the control unit 111 of the AI care device 101 generates the control signal S5 to be transmitted to the multimedia device 107 or the user 105.

In other words, when the voice signal S1 of the user, for example, a voice command and voice calling, cannot be detected in the voice signal S1 and the audio signal S3 applied at the same time, the control unit 111 generates the control signal S5 to be transmitted to the multimedia device 107 or the user 105.

Meanwhile, when the control signal S5 is a signal to be transmitted to the multimedia device 107, the AI based method for controlling a multimedia device according to an embodiment of the present disclosure further includes, after the step (c), applying, by a communication unit 113 of the care device 101, the control signal S5 to the multimedia device 107.

Here, the communication unit 113 may use short range communication technology, for example, Bluetooth, Radio Frequency Identification (RFID), Infrared Data Association (IrDA), Ultra Wideband (UWB) and ZigBee.

Meanwhile, the control signal S5 that the communication unit 113 applies to the multimedia device 107 may be a control signal for reducing or muting the volume of the multimedia device 107.

That is, when the determination unit 109 of the care device 101 determines that it is impossible to extract only the voice signal S1 from the voice signal S1 and the audio signal S3 applied at the same time, the control unit 111 applies the control signal S5 for reducing or muting the volume of the multimedia device 107 to the multimedia device 107 to reduce or mute the volume of the audio signal S3 outputted from the multimedia device 107, in order to enable the determination unit 109 to accurately detect and determine the voice signal S1 of the user 105.

Additionally, when the control signal S5 is a signal to be transmitted to the user 105, the AI based method for controlling a multimedia device according to an embodiment of the present disclosure further includes, after the step (c), transmitting, by a speaker unit 115 of the care device 101, the control signal S5 by audio.

Here, the control signal S5 is a voice signal for guiding the user 105 to reduce or mute the volume of the multimedia device 107.

That is, when the determination unit 109 of the care device 101 determines that it is impossible to extract only the voice signal S1 from the voice signal S1 and the audio signal S3 applied at the same time, the control unit 111 may generate a voice signal (such as, for example, voice guidance “please reduce the volume of the TV.”, “please mute the volume of the TV.”) for guiding the user 105 to reduce or mute the volume of the multimedia device 107, and the speaker unit 115 may transmit the control signal S5 by voice to allow the user 105 to reduce or mute the volume of the multimedia device 107.

Through this, the determination unit 109 may accurately detect and determine the voice signal S1 of the user 105.

The communication unit 113 and the speaker unit 115 described above may be mounted on the AI care device 101 together or separately.

Meanwhile, the AI based system for controlling a multimedia device according to another embodiment of the present disclosure includes the multimedia device 107 to generate the audio signal S3 while outputting the multimedia content; and the AI care device 101 including the input unit 103 to receive the voice signal S1 of the user 105 and the audio signal S3 at the same time; the determination unit 109 to determine whether it is possible or impossible to extract only the voice signal S1 from the voice signal S1 and the audio signal S3 applied at the same time; and the control unit 111 to generate the control signal S5 to be transmitted to the multimedia device 107 or the user 105 when it is impossible to extract only the voice signal S1.

Additionally, when the control signal S5 is a signal to be transmitted to the multimedia device 107, the AI care device 101 further includes the communication unit 113 to apply the control signal S5 to the multimedia device 107.

In this instance, the control signal S5 may be a control signal for reducing or muting the volume of the multimedia device 107.

Additionally, when the control signal S5 is a signal to be transmitted to the user 105, the AI care device 101 further includes the speaker unit 115 to transmit the control signal S5 by audio.

Here, the control signal S5 may be a voice signal for guidance to reduce or mute the volume of the multimedia device 107.

Meanwhile, the functions and features of each component of the AI based system for controlling a multimedia device according to another embodiment of the present disclosure as described above are the same as those described above in the AI based method for controlling a multimedia device, and its detailed description is omitted.

As described above, according to an embodiment of the present disclosure, it is possible to ensure accuracy in detection and interpretation of the voice command of the user by enabling the AI care device to control the volume of the multimedia device by itself or allow the user to control the volume of the multimedia device by transmitting voice guidance for volume control to the user when the AI care device does not accurately detect the voice signal of the user due to the audio signal of the multimedia device and the voice signal of the user applied to the AI care device at the same time.

Although it has been described that all the constituent elements in the embodiments of the present disclosure are combined into one or operate in combination, the present disclosure is not necessarily limited to these embodiments. That is, all the elements may operate in at least one selective combination within the intended scope of the present disclosure.

The foregoing description is made to describe the technical spirit of the present disclosure by way of illustration, and it is obvious to those skilled in the art that a variety of modifications and changes will be made without departing from the essential features of the present disclosure. Accordingly, the embodiments disclosed herein are provided to describe, but not intended to limit, the technical spirit of the present disclosure, and the technical spirit and scope of the present disclosure is not limited by these embodiments. The scope of protection of the present disclosure should be interpreted by the appended claims, and it should be interpreted that the full technical spirit in the equivalent scope falls within the scope of protection of the present disclosure.

1. An artificial intelligence (AI) based method for controlling a multimedia device, the method comprising:
receiving, by an input unit of an AI care device, a voice signal of a user and an audio signal of a multimedia device which outputs multimedia content at the same time;
determining, by a determination unit of the care device, whether it is possible or impossible to extract only the voice signal from the voice signal and the audio signal applied at the same time; and
generating, by a control unit of the care device, a control signal to be transmitted to the multimedia device or the user when it is impossible to extract only the voice signal.

2. The AI based method of claim 1, further comprising:
applying, by a communication unit of the care device, the control signal to the multimedia device when the generated control signal is a signal to be transmitted to the multimedia device.

3. The AI based method of claim 1, further comprising:
transmitting, by a speaker unit of the care device, the control signal by audio when the generated control signal is a signal to be transmitted to the user.

4. The AI based method of claim 2, wherein the control signal is a control signal for reducing or muting a volume of the multimedia device.

5. The AI based method of claim 3, wherein the control signal is a voice signal for guidance to reduce or mute a volume of the multimedia device.

6. An artificial intelligence (AI) based system comprising:
a multimedia device to generate an audio signal while outputting multimedia content; and
an AI care device including an input unit to receive a voice signal of a user and the audio signal at the same time; a determination unit to determine whether it is possible or impossible to extract only the voice signal from the voice signal and the audio signal applied at the same time; and a control unit to generate a control signal to be transmitted to the multimedia device or the user when it is impossible to extract only the voice signal.

7. The AI based system of claim 6, wherein the AI care device further includes:
a communication unit to apply the control signal to the multimedia device when the control signal is a signal to be transmitted to the multimedia device.

8. The AI based system of claim 6, wherein the AI care device further includes:
a speaker unit to transmit the control signal by audio when the control signal is a signal to be transmitted to the user.

9. The AI based system of claim 7, wherein the control signal is a control signal for reducing or muting a volume of the multimedia device.

10. The AI based system of claim 8, wherein the control signal is a voice signal for guidance to reduce or mute a volume of the multimedia device.
